(19) United States
(12) Patent Application Publication
(10) Pub. No.: US 2012/0308180 A1
(43) Pub. Date: Dec. 6, 2012

(54) Quad Small Form Factor Plus Pluggable Module for Medium Range Single Mode Fiber Applications

(75) Inventors: Carlo Tosetti, Sondrio (IT); Damiano Rossetti, Monza (IT); Mala Krishnan, Petaluma, CA (US); Marco Mazzini, Milano (IT)

(73) Assignee: CISCO TECHNOLOGY, INC., San Jose, CA (US)

(21) Appl. No.: 13/150,597

(22) Filed: Jun. 1, 2011

(51) Int. Cl. G02B 6/26

(52) U.S. Cl. 385/28; 385/27

(57) ABSTRACT

An apparatus is provided comprising a small form factor pluggable module having an optical connector configured to be coupled to a plurality of transmit and receive single mode optical fibers and an optical transmitter comprising a plurality of uncooled laser diodes configured to transmit optical signals to a plurality of transmit single mode optical fibers via the optical connector. The small form factor pluggable module is a quad small form factor pluggable plus (QSFP+) 40GBASE-SR4 module that has been converted for use with single mode fibers by substituting their vertical-cavity surface emitting laser diodes (VCSEL) with longer range uncooled laser diodes. Example replacement lasers may include uncooled Fabry-Perot (FP) laser diodes or Distributed Feedback (DFB) laser diodes. To connect the module to lower grade fibers, a single mode-to-multimode mode conditioning patch cord is provided with a plurality of inline physical offsets, one for each pair of fibers.

### TECHNICAL FIELD

The present disclosure generally relates to quad small form factor pluggable plus (QSPF+) 40GBASE-SR4 modules.

### BACKGROUND

The Institute of Electrical and Electronic Engineers (IEEE) sets forth standards for particular rates of data transmission. For example, the IEEE 802.3ae describes 10GBASE-SR (short range) and 10GBASE-LR (long reach) standards for transmission of serialized data at a nominal rate of 10 Gigabits per second over multimode and single mode fiber optical cables, respectively. The optical transmissions for short range implementations may be made over distances from up to 82 to 300 meters depending on the grade of multimode fiber in use and whether or not electronic dispersion compensation is performed at the receiver. 10GBASE-LR implementations are designed to transmit data up to 10 kilometers over a single mode fiber. The main objective of the 10GBASE-SR standard is to provide a cost effective and highly scalable 10 Gigabit Ethernet implementation over an optical cabling infrastructure that is widely used in data centers or buildings. To achieve higher data rates, e.g., 40 or 100 Gigabit per second Ethernet, four or ten 10GBASE-SR channels may be employed in a single pluggable module, e.g., a 40GBASE-SR4 or 100GBASE-SR10 module.

### BRIEF DESCRIPTION OF THE DRAWINGS

FIG. 1 is a block diagram depicting examples of functional components of a modified quad small form factor pluggable plus (QSPF+) 40GBASE-SR4 module.

FIG. 2 is diagram showing an example of a cable configured to provide fiber optic cable mode conditioning for a plurality of multimode fibers coupled to single mode fibers using a physical offset.

FIG. 3 is diagram showing an example of the physical offset used in the ribbon cable of FIG. 2.

FIG. 4 is an example of a graphical plot of spectral width against wavelength for an uncooled laser to achieve a one kilometer transmission distance over a single mode fiber.

### DESCRIPTION OF EXAMPLE EMBODIMENTS

Overview

In one form, an apparatus is provided comprising a small form factor pluggable module comprising an optical connector configured to be coupled to a plurality of transmit and receive single mode optical fibers and an optical transmitter comprising a plurality of uncooled laser diodes configured to transmit optical signals to a plurality of transmit single mode optical fibers via the optical connector.

The small form factor pluggable module may be, for example, a quad small form factor pluggable plus (QSFP+) 40GBASE-SR4 or 40GBASE-LRM (long reach multimode) module that has been converted for use with single mode fibers. In this regard, the optical connector may be substituted or replaced with a single mode fiber optical connector, e.g., a multiple fiber push-on/pull-off (MPO) or a mechanical transfer pull-off (MTP) connector. To achieve a greater range, the SR or LRM modules have their vertical-cavity surface emitting laser (VCSEL) diodes substituted or replaced with longer range, yet uncooled laser diodes. Example replacement lasers may include uncooled Fabry-Perot (FP) or distributed feedback (DFB) laser diodes.

The module can achieve transmission ranges in the neighborhood of one kilometer for single mode fiber and higher grade OM3 and OM4 multimode fibers when using electronic dispersion compensation (EDC). Lower grade or older optical fibers such as OM1, OM2, or Fiber Distributed Data Interface (FDDI) require mode compensation when the optical transmission is traversing from a single mode fiber to a multimode fiber due to the centerline core defect in these lower grade fibers. To connect the module to these lower grade fibers, a single mode to multimode mode conditioning patch cord is provided with a plurality of inline physical offsets, one for each mating pair of fibers.

### Example Embodiments

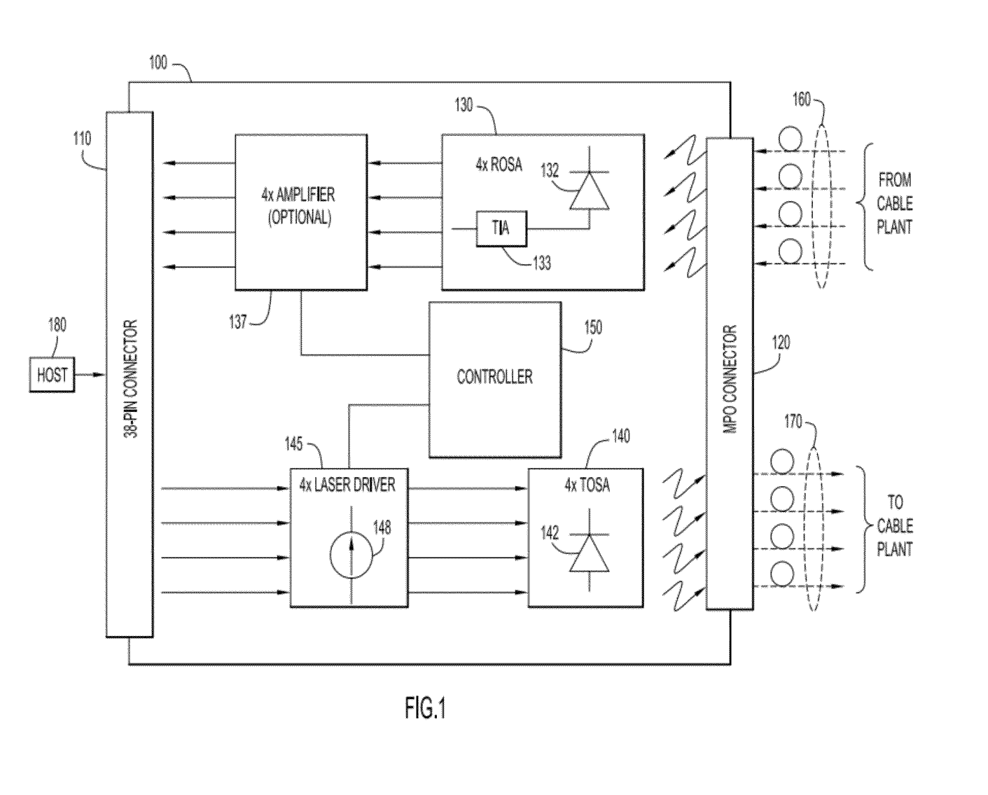

FIG. 1 is a block diagram depicting an example of functional components of a module 100 comprising a QSPF+40GBASE-SR4 pluggable module The module 100 has a 38-pin backplane connector 110, an MPO connector 120, a four channel receive optical subassembly (ROSA) 130, an optional four channel amplifier 137, a four channel transmit optical subassembly (TOSA) 140 and a four channel laser driver 145, and a controller 150. The controller 150 may be in the form of an integrated circuit. The 38-pin backplane connector 110 is connected to a host device 180. The MPO connector 120 is connected to four single mode or multimode receive optical fibers 160 and four single mode transmit optical fibers 170.

Inbound optical signals are received at module 100 by way of the four receive optical fibers 160. The optical signals are optically channeled to corresponding photodiodes 132. For simplicity, only one of the four photodiodes 132 is depicted. The photodiodes convert the optical signals to electrical signals by producing a current that is proportional to the optical signal strength. The current signal can be used to detect the underlying data within the optical signal. To convert the current signal to a voltage, an optional linear transimpedence amplifier 133 is provided for each photodiode. The voltage signal from the transimpedence amplifier 133 may be amplified by the four channel amplifier 137 and sent to host 180 via backplane connector 110. The host may perform EDC on the received signal or EDC may be performed on module 100 by controller 150 or another circuit.

On the outbound path, digital electronic signals are received by the four channel laser driver 145 from host 180 via backplane connector 110. Each of the four outbound paths has a corresponding laser driver 148 for generating laser driver electronic signals for each of the four laser diodes 142 in TOSA 140. The laser diodes 142 convert the laser driver electronic signal to an optical signal. The optical signals produced by the laser diodes 142 are optically channeled to the four single mode transmit optical fibers 170 by way of MPO connector 120.

The controller 150 may be a microprocessor, a microcontroller, systems on a chip (SOCs), field programmable gate array (FPGA)), or other fixed or programmable logic. The functions of the controller 150 may be implemented by a processor or computer readable tangible (non-transitory) medium encoded with instructions or by logic encoded in one or more tangible media (e.g., embedded logic such as an application specific integrated circuit (ASIC), digital signal processor (DSP) instructions, software that is executed by a processor, etc.). Instructions or configuration parameters may be stored in a non-volatile memory (NVM).

Traditional 10GBASE-SR applications use VCSELs that operate in the 850 nanometer (nm) wavelength range using multimode fiber. The maximum transmit range for older fiber designs is approximately 26 to 82 meters while maintaining an acceptable bit error rate (BER). The range can be extended to 300 meters by using OM3 multimode fiber. GBASE-LRM applications use FP or DFB lasers that operate in the 1310 nanometer (nm) range using multimode fiber. The maximum transmit range is approximately 220 meters for FDDI and 260 meters for OM3. LRM applications use EDC for equalization on the receive signal.

To achieve longer transmit ranges, the 40GBASE-LR4 (long range) specifies ranges of at least 10 kilometers over a single mode fiber for a nominal data rate of 40 Gigabits per second. The prefixes for each numbered standard indicate the data rate it is designed to support, e.g., 10G, 40G, and 100G indicate data rates of 10, 40, and 100 Gigabits per second (G). The suffixes for each numbered standard indicated the transmit range, e.g., short range or long range. To achieve 10 kilometer transmit ranges and beyond, the transceiver modules must use more powerful lasers that consume more power. The higher power levels also produce more heat. To compensate for the higher thermal loads the lasers or TOSAs are cooled, usually by thermo-electric cooling (TEC). The cooling also has the benefit of extending the life of the laser. Currently, these thermally cooled lasers are considerably more expensive than VCSELs.

The current set of specifications thus provide ranges of 300 meters and below, and 10 kilometers and above. To achieve a transmit range above 300 meters but less than 10 kilometers, a long reach Physical Medium Dependent (PMD) sublayer, i.e., a long range physical layer, would be used because that is what is currently available and specified. However, LR PMDs would be considered expensive and “overkill” for a mid-range application, e.g., one kilometer.

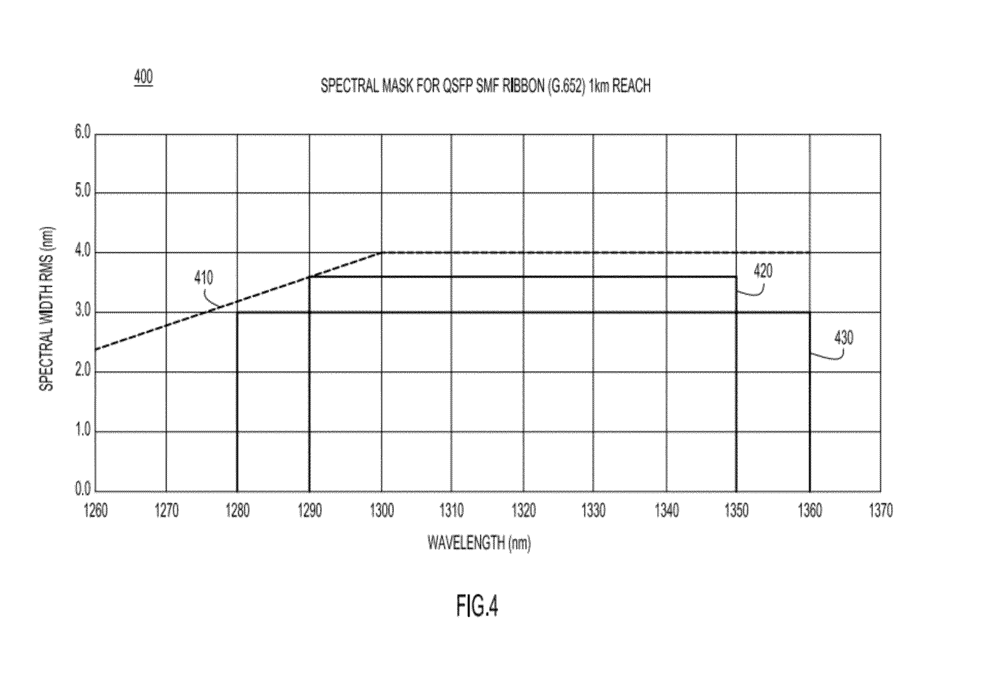

In order to keep the overall pluggable cost and power consumption low, the 40GBASE-SR4 QSFP+ design can be transposed into a single mode fiber environment by replacing the four VCSELs with four Fabry-Perot lasers and using a single mode fiber instead of a multimode fiber ribbon cable. The QSFP+ pluggable uses an MPO/MTP connector so that a single mode fiber ribbon cable may be used. The MPO/MTP connector is a parallel optics assembly that allows each Fabry-Perot laser transmission to propagate along a different individual fiber to reach the intended receiver without any multiplexing or demultiplexing of wavelengths, as is the case with when using LR4 PMDs. The use of four different fibers as a propagation medium for each of the four transmitters allows for the use of uncooled Fabry-Perot lasers, thereby lowering the overall power consumption requirements of the pluggable. The use of uncooled Fabry-Perot sources limits the maximum single mode fiber link length to about one kilometer. The one kilometer link may be referred to herein as medium range (MR) links (e.g., an MR4 application). To support a one kilometer link a short reach spectral mask is provided as part of the Fabry-Perot laser. The spectral mask will be described hereinafter in connection with FIG. 4. Furthermore, the use of 1300 nm laser sources enables the support of LRM-like links, e.g., 220 meters over OM1/2/3 fibers in ribbon cables. For LRM applications, the receiver side may be equipped with a linear interface in order to use EDC, e.g., a linear transimpedence amplifier.

Thus, the techniques described herein provide a lower cost alternative to the more expensive TOSAs with TEC by using lower cost SR modules and replacing the VCSELs with higher power lasers without using TEC. Nominally, transmit distances of one kilometer can be achieved using both single and multimode fibers. One kilometer transmit distances provide an intermediate transmit distance that is useful in many campus and metropolitan area networks. At the same time, this low cost solution for a 40G QSFP+ pluggable supports LRM-like applications.

In addition, the techniques described herein provide for a mode conditioning patch cord or other inline mode conditioning unit for multiple transmit fibers. 10GBASE-LRM compatible links may require a mode conditioning patch cord at the transmitter-fiber interface to close the link when the propagation medium is either type OM1 or OM2. These are legacy fibers, where a center defect in the refractive index profile causes the overall Overfilled (OFL) Bandwidth (BW) to drop considerably. OFL BW is one primary metric used for evaluating multimode fiber throughput capability. The mode conditioning patch cord overcomes this issue by offsetting the transmit laser launch spot into the multimode fiber so that the signal propagates far away from fiber's center, enabling a higher effective bandwidth. Mode conditioning patch cords are not available for 40GBASE applications.

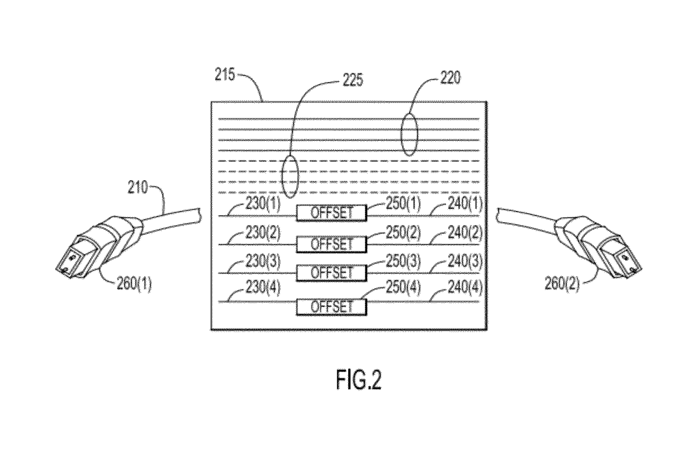

Referring to FIG. 2, an example of a 12 strand mode conditioning patch cord 210 is shown. At 215, a blown up view of the 12 internal optical fibers is shown. The fibers are shown as a series of horizontal lines from top to bottom. The fibers are arranged in FIG. 2 for ease of illustration and may not be representative of the actual internal physical arrangement of fibers within patch cord 210. Active fibers are shown as solid lines while inactive or unused fibers are shown as dashed lines. Two connectors 260(1) and 260(2) are provided at respective ends of the mode conditioning patch cord 210. Connector 260(1) is configured to attach to the MR QSFP+ module and connector 260(2) is configured to provide a connection to an LRM link. The number of fibers shown in FIG. 2 is not meant to be limiting.

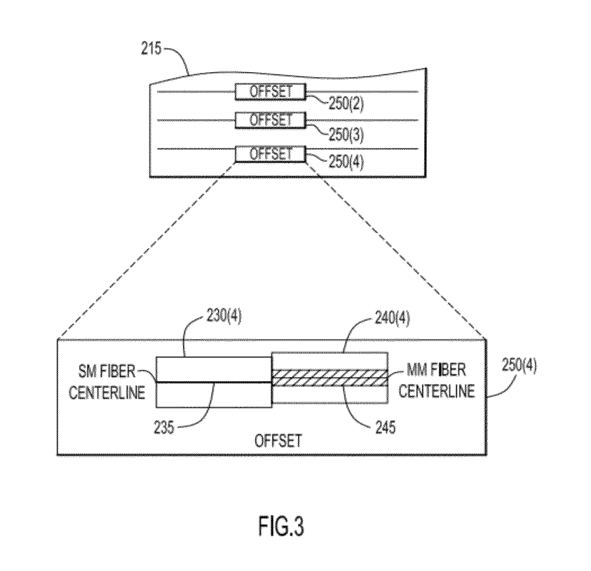

The patch cord 210 has four receive fibers collectively shown at 220 and four unused fibers collectively shown at 225. The fibers 220 are termed receive fibers with respect to the MR QSFP+ module, i.e., the receive fibers 220 provide optical signals to ROSA 130 from FIG. 1. On the transmit side, with respect to the MR QSFP+ module, the patch cord 210 has four transmit single mode fibers 230(1)-230(4) and has four transmit multimode fibers 240(1)-240(4). At connection points between the single mode fibers 230(1)-230(4) and the transmit multimode fibers 240(1)-240(4) are four physical offsets 250(1)-250(4), respectively. The physical offsets 250(1)-250(4) will be described next in connection with FIG. 3.

Referring to FIG. 3, one of the physical offsets 250(4) from FIG. 2 is shown in detail. The lower part of the blown up view 215 is shown as a frame of reference. Offset 250(4) is provided at an interface between one end of single mode fiber 230(4) and one end of multimode fiber 240(4). The multimode fiber 240(4) has an optical glass core 245 that ranges from 50 to 62.5 microns or ±25-31.25 microns about a centerline, while the single mode fiber 230(4) has an optical glass core 235 that ranges from 8 to 10 microns or ±4-5 microns about its centerline. Accordingly, the single mode fiber core 235 has a considerable surface area for alignment with the multimode fiber core 245 and still is able to transfer an optical signal to the multimode fiber. However, when the single mode fiber core 235 and multimode fiber core 245 are aligned with each other the OFL BW drops considerably due to an inherent defect at the center of the multimode fiber core 245. In this example, the centerline of single mode fiber core 235 is physically offset from the centerline of multimode fiber core 245 as shown so that, for example, the centerline of single mode optical fiber core 235 is aligned in the middle of the lower half of the core 245 of multimode fiber 240(4). Accordingly, mode conditioning can be provided for a plurality of multimode fibers coupled to single mode fibers in a single ribbonized connector.

Turning now to FIG. 4, a graphical illustration of a spectral mask for an MR QSFP+ module with Fabry-Perot lasers is shown at 400. The Fabry-Perot lasers are designed to operate in the 1310 nm band. The spectral mask (or channel mask) is designed to limit spurious emissions outside of the intended transmission bandwidth. The graph 400 plots spectral width in nanometers against wavelength. At 410, a reference line is shown that indicates an upper limit on spectral width that should guarantee a transmission link distance of 800 meters over single mode fiber and OM3/OM4 fiber.

At 420 and 430, two different spectral masks are shown that may be used for a Fabry-Perot laser design that allows a one kilometer link distance to be attained. Spectral mask 420 allows a spectral width of approximately 3.6 over wavelengths from 1290 nm to 1350 nm. Spectral mask 430 allows a lower spectral width of approximately 3.0 but over a broader range of wavelengths from 1280 nm to 1360 nm. The spectral mask was generated from known mathematical relationships defined in the IEEE standards. The spectral width (measured in nm) is a measurement that represents the average width of the source spectrum. Spectral width is a parameter which measures how many spectral components are present. For example, DFB lasers show a very narrow spectral width, i.e., the DFB is monochromatic, while FP lasers or LEDs show high spectral width, i.e., their light is composed of a larger number of spectral components (colors).

In sum, an apparatus is provided comprising: a small form factor pluggable module comprising an optical connector configured to be coupled to a plurality of transmit and receive single mode optical fibers; and an optical transmitter comprising a plurality of uncooled laser diodes configured to transmit optical signals to a plurality of transmit single mode optical fibers via the optical connector. The plurality of uncooled laser diodes are configured to operate with a maximum predetermined spectral width over a defined range of wavelengths in order to allow the plurality of uncooled laser diodes to achieve a transmit range of approximately one kilometer. The uncooled laser diodes are configured to transmit the optical signals beyond ranges specified in the 10GBASE-SR or 10GBASE-LRM standards.

The small form factor pluggable module may also comprise: an optical receiver comprising a plurality of photodiodes configured to detect received optical signals; and an optical dispersion compensation unit configured to apply electronic dispersion compensation to the received optical signals. The optical receiver may be further provisioned with a linear transimpedence amplifier.

The small form factor pluggable module may be, for example, a QSFP+ 40GBASE-SR4 module that has been converted for use with single mode fibers. In this regard, the optical connector may be substituted with an MPO/MTP connector. To achieve a greater range, the SR modules have their VCSELs substituted, e.g., during manufacture, with a longer range, uncooled laser. Example replacement lasers may include uncooled Fabry-Perot or DFB laser diodes.

The module can achieve transmission ranges in the neighborhood of one kilometer for single mode fiber, and higher grade OM3 and OM4 multimode fibers when using EDC. Lower grade or older optical fibers such as OM1, OM2, or FDDI require mode compensation when the optical transmission is traversing from a single mode fiber to a multimode fiber due to the core defect in these lower grade fibers.

To connect the module to these lower grade fibers, a single mode-to-multimode mode conditioning patch cord is provided with a plurality of inline physical offsets, one for each pair of fibers. The patch cord is a cable comprising a plurality of single mode optical fibers and a plurality of multimode optical fibers. Each individual single mode fiber being physically offset at a connection point with a corresponding individual multimode fiber so that an optical center of a single mode fiber is physically offset from an optical center of a corresponding multimode fiber.

The above description is intended by way of example only. Various modifications and structural changes may be made therein without departing from the scope of the concepts described herein and within the scope and range of equivalents of the claims.

1. An apparatus comprising:
a small form factor pluggable module comprising an optical connector configured to be coupled to a plurality of transmit and receive single mode optical fibers; and
an optical transmitter comprising a plurality of uncooled laser diodes configured to transmit optical signals to a plurality of transmit single mode optical fibers via the optical connector.

2. The apparatus of claim 1, wherein the plurality of uncooled laser diodes are configured to operate with a predetermined spectral width over a defined range of wavelengths in order to allow the plurality of uncooled laser diodes to achieve a transmit range of approximately one kilometer over single mode fiber.

3. The apparatus of claim 1, wherein the uncooled laser diodes are configured to transmit the optical signals beyond ranges specified in the 10GBASE-SR standards.

4. The apparatus of claim 1, wherein the plurality of uncooled laser diodes comprise Fabry-Perot or distributed feedback laser diodes.

5. The apparatus of claim 1, wherein the plurality of uncooled laser diodes are configured to operate in a 1310 nanometer wavelength range.

6. The apparatus of claim 1, wherein the optical connector comprises a multiple fiber push-on/pull-off or a mechanical transfer pull-off connector.

7. The apparatus of claim 1, wherein the small form factor pluggable module comprises a quad small form factor plus (QSFP+) pluggable module configured for use with vertical-cavity surface emitting laser diodes, and wherein the plurality of uncooled laser diodes are configured to operate over a greater distance than vertical-cavity surface emitting laser diodes.

8. The apparatus of claim 1, further comprising:
an optical receiver comprising a plurality of photodiodes configured to detect received optical signals; and
an optical dispersion compensation unit configured to apply electronic dispersion compensation to the received optical signals.

9. The apparatus of claim 8, wherein the optical receiver further comprises a linear transimpedence amplifier.

10. A system comprising the apparatus of claim 1, and comprising an optical ribbon cable configured to be connected to the optical connector.

11. The system of claim 10, wherein the optical ribbon cable comprises a plurality of single mode optical fibers.

12. The system of claim 10, wherein the optical ribbon cable comprises a plurality of multimode optical fibers.

13. The system of claim 12, wherein the multimode optical fibers comprise OM3 or OM4 optical fibers.

14. The system of claim 12, further comprising a mode conditioning unit coupled between the optical connector and the multimode optical fibers, the mode conditioning unit comprising:
a plurality of single mode fibers;
a connector coupled to the plurality of single mode fibers and configured to connect the plurality of single mode fibers to the optical transmitter via the optical connector; and
each individual single mode fiber being physically offset at a connection point with a corresponding individual multimode fiber so that an optical center of a single mode fiber is physically offset from an optical center of a corresponding multimode fiber.

15. An apparatus comprising:
a plurality of uncooled laser diodes mounted on a quad small form factor plus (QSFP+) pluggable module and configured to transmit on a plurality of corresponding single mode fiber links with a length greater than 300 meters; and
a plurality of laser drivers configured to drive a corresponding uncooled laser diode.

16. The apparatus of claim 15, wherein the quad small form factor pluggable plus (QSFP+) module comprises a 40GBASE-SR4 module configured for use with vertical-cavity surface emitting laser diodes, and wherein the plurality of uncooled laser diodes are configured to operate over a greater distance than vertical-cavity surface emitting laser diodes.

17. The apparatus of claim 16, wherein the plurality of uncooled laser diodes are configured to operate with a predetermined spectral width over a defined range of wavelengths in order to allow the plurality of uncooled laser diodes to achieve a transmit range of approximately one kilometer over single mode fiber.

18. The apparatus of claim 16, wherein the plurality of uncooled laser diodes comprise Fabry-Perot or distributed feedback laser diodes.

19. The apparatus of claim 16, wherein the plurality of uncooled laser diodes are configured to operate in a 1310 nanometer wavelength range.

20. An apparatus comprising:
a cable comprising a plurality of single mode optical fibers and a plurality of multimode optical fibers; and
each individual single mode fiber being physically offset at a connection point with a corresponding individual multimode fiber so that an optical center of a single mode fiber is physically offset from an optical center of a corresponding multimode fiber.

21. The apparatus of claim 20, wherein the multimode optical fibers comprise OM1, OM2, or Fiber Distributed Data Interface (FDDI) optical fibers.
